(19) United States
(12) Patent Application Publication
(10) Pub. No.: US 2006/0222764 A1
(43) Pub. Date: Oct. 5, 2006

(54) Method and apparatus for rubbing alignment films

(75) Inventor: Chiao Chung Huang, Taoyuan Hsien (TW)

Correspondence Address: BRUCE H. TROXELL;SUITE 1404, 5205 LEESBURG PIKE, FALLS CHURCH, VA, 22041, US

(73) Assignee: AU OPTRONICS CORP.

(21) Appl. No.: 11/446,175

(22) Filed: Jun. 5, 2006

Related U.S. Application Data
(62) Division of application No. 10/761,332, filed on Jan. 22, 2004.

(30) Foreign Application Priority Data
May 28, 2003 (TW) 92114385

(51) Int. Cl. B05D 5/06; B05D 3/12

(52) U.S. Cl. 427/162; 427/355

(57) ABSTRACT

A method for rubbing alignment films and an apparatus for processing the same are introduced. The method includes a step of providing a glass substrate coated by an alignment film and further having a visible region and an invisible region, a step of moving the glass substrate along a predetermined direction, and a step of rubbing the alignment film by an inversed roller with cloth on a surface thereof along an in-stream direction the same as the predetermined direction while the glass substrate is moving. By reverse rolling upon the alignment film, chips rubbed off the alignment film can be made not to hard contact with the alignment film on the visible region which has been rubbed by the cloth.

### RELATED APPLICATIONS

This application is a Divisional application of U.S. Ser. No. 10/761,332 filed on Jan. 22, 2004 and currently pending.

### BACKGROUND OF THE INVENTION

(1) Field of the Invention

The invention relates to a method and an apparatus for rubbing alignment films, and more particularly to the apparatus that utilizes a roller device to rub the alignment films for liquid crystal displays at a particular direction.

(2) Description of the Prior Art

Due to the rapid technology progress in the industry of thin film transistor (TFT) liquid crystal displays (LCD) and the accompanying advantages in thickness, energy-saving and less radiation, the LCDs have been widely applied to various electronic devices such as personal digital assistants (PDA), notebook computers, digital cameras, video recorders and mobile phones. Further, with the help of mega investment in research as well as in manufacturing facilities, the quality of the LCDs is kept improving while the price is kept reducing. Definitely, the market of LCDs will be blooming to the next decade.

Referring to FIG. 1, a schematic view show the stacking of a typical LCD 10. As shown, the LCD 10 includes a back light 11, two polarizers 12, two glass substrates 13a and 13b, two alignment films 14 and a liquid crystal layer 15. It is noted that spacings between layers exist purposely in FIG. 1 to clearly distinguish different layers. However, for a skilled person in the art, it should be understood that those layers in the LCD 10 are actually arranged by a face-to-face piling without visible spacing. The back light 11 is used to form a uniform white light source. The polarizer 12 is used to polarize the passing light. The lower glass substrate 13b further includes a plurality of thin film transistors 16 for providing voltages to control orientations of the liquid crystal layer 15. On the other hand, the upper glass substrate 13a includes a layer of color filter film to decompose the incoming white light into a red light, a green light and a blue light. In addition, it is shown that the liquid crystal layer 15, which is shielded by the alignment films 14 at both sides, is sandwiched between the upper glass substrate 13a and the lower glass substrate 13b so as to evenly distribute the liquid crystals thereinside and also reduce the possibility of light distraction or light leakage.

Referring to FIG.2, a top view and a side view are used to show a typical structure of the alignment film 14 and the glass substrate 13. Specifically, the alignment film 14 is an organic film with a thickness of about 500 to 1000 angstroms laid on the surface of the glass substrate 13. The organic material can be a polyamic acid, a polyamide, or the like. As shown, the glass substrate 13 includes a visible central region 131 and an invisible perimeter region 132. The visibility of the glass substrate 13 is contributed by the well-known technique of black matrix (BM). Since a plurality of thin film transistors 16 or transparent electrode elements are mounted on the visible central region 131, the visible central region 131 is thicker than the invisible perimeter region 132. Also, the alignment film 14 on the glass substrate 13 shows an elevation drop at the conjunction of the visible central region 131 and the invisible perimeter region 132. Upon such an elevation drop, a rubbing alignment treatment or a so-called lapping onto the alignment film 14 is usually required so as to align the liquid crystals thereunder.

Referring to FIG. 3, a schematic view of a facility for aforesaid rubbing alignment treatment is shown. The facility includes a conveying device 32 to transport longitudinally along an X direction a plurality of carrier plates 30 which can further carry the glass substrate 13. The glass substrate 13 disposed on the respective carrier plate 30 is posed by having the alignment film 14 exposed on top. Along the path of the conveying device 32, a roller 34 is constructed at the midway. The roller 34, which is surfaced by a cloth, is used to rub the alignment film 14 of the glass substrate 13 at an in-flow direction shown by the arrow of FIG. 3. After being rubbed by the roller 34, the alignment film 14 can then have the liquid crystals thereinside evenly and orderly distributed. Specifically, the glass substrate 13 and the roller 34 are arranged with a predetermined angle such as a 45-degree angle.

Referring to FIG.4, a rubbing operation of the roller 34 upon the alignment film 14 of the glass substrate 13 is schematically shown. It is noted that the roller 34 rubs the alignment film 14 in a down-stream style which the tangential direction of velocity of a lower portion of the roller 34 is 180 degree reversed to the feeding direction X of the glass substrate 13. While in the rubbing operation, the existence of the elevation drops at the conjunction of the visible region 131 and the invisible region 132, shown at A-A′ and B-B′ in FIG. 4, will make the chip 40 turned back to reside on the alignment film 14 after rolling with the roller 34. It is obvious that the residue chip 40 on the alignment film 14 will obstacle the feeding of the glass substrate 13 and have a pretty possibility to make scratches to both the roller 34 surface and the alignment film 14.

As shown in FIG. 4, a typical scratch shown in a dotted line on the alignment film 14 may be generated by the residue chip 40. The dotted-lined scratch located in the visible region 131 spaces from the A-A′ line by about a centimeter. It is noted that the invisible region 132 may have scratches as well. Yet, the scratches in the invisible region 132 can only have a dim effect or no effect on the display quality the of the LCD so that those scratches are not discussed further in this description. However, the presence of scratches in the visible region 131 will influence severely the display quality of the LCD and can make the brightness of the display unevenly. This is known in the art as a MURA phenomenon.

As described above, a linear scratch is quite possible to occur in the visible region 131 of an LCD in a rubbing operation and to induce thereafter a MURA phenomenon, which degrades the visibility of the LCD. Therefore, any research devoted to overcoming the scratch problem in the rubbing operation is definitely highly welcomed to the skilled person in the art.

### SUMMARY OF THE INVENTION

Accordingly, it is an object of the present invention to provide a method for rubbing alignment films, by which the scratch problem in the visible region can be resolved and thus the display quality of the LCD can be ensured.

It is another object of the present invention to provide an apparatus for rubbing alignment films which can perform the rubbing operation upon the alignment film without scratching the visible region of the LCD and thus can better satisfy consumers' need in display comfort.

The method for rubbing alignment films in accordance with the present invention firstly provides a glass substrate which further includes a visible region and an invisible region. The glass substrate is coated on-top by an alignment film. Secondly, a conveying device is used to transport the glass substrate along a predetermined direction. While in moving the glass substrate, an inversed roller with cloth on a surface thereof is utilized to rub the alignment film of the glass substrate. In particular, an angle is preset between the glass substrate and the inversed roller so as to have the alignment direction of the liquid crystals coherent to the rubbing direction of the inversed roller.

Though chips may be generated off the alignment film at the conjunction of the visible region and the invisible region during the rubbing, yet the chips may either be thrown on the rubbed alignment film or be carried by the cloth of the inversed roller and travel a roller turn before drop back to the alignment film. Also, since the inversed roller is in-stream rotated with respect to the feeding direction of the alignment film, the chips carried away by the inversed roller will drop back to an yet-to-rub side of the alignment film, i.e. the upstream side of the conveying device, and thus make no harm or scratch to the alignment film that has been rubbed. Upon such an arrangement, the already-rubbed alignment film can be free of hard contact by the depressed chips under the roller, and then the visible region of the glass substrate can be thus free of scratches or dents by the chips.

All these objects are achieved by the method and the apparatus for rubbing alignment films described below.

### BRIEF DESCRIPTION OF THE DRAWINGS

The present invention will now be specified with reference to its preferred embodiment illustrated in the drawings, in which:

FIG. 1 is a schematic view of a conventional LCD showing a stack of major components;

FIG. 2 is a top view and a side view showing a combination of a glass substrate, a thin film transistor and an alignment film;

FIG. 3 is a perspective view of a conventional apparatus for rubbing alignment films;

FIG. 4 is a schematic enlarged view showing a conventional rubbing operation of the roller upon a glass substrate having an alignment film;

FIG. 5 is a perspective view of a preferred apparatus for rubbing alignment films in accordance with the present invention;

FIG. 6 is a schematic enlarged view showing a rubbing operation of the roller upon a glass substrate having an alignment film in accordance with the present invention;

FIG. 7A is a schematic view showing the conventional relationship between a roller and a glass substrate; and

FIG. 7B is a schematic view showing the relationship between an inversed roller and a glass substrate in accordance with the present invention.

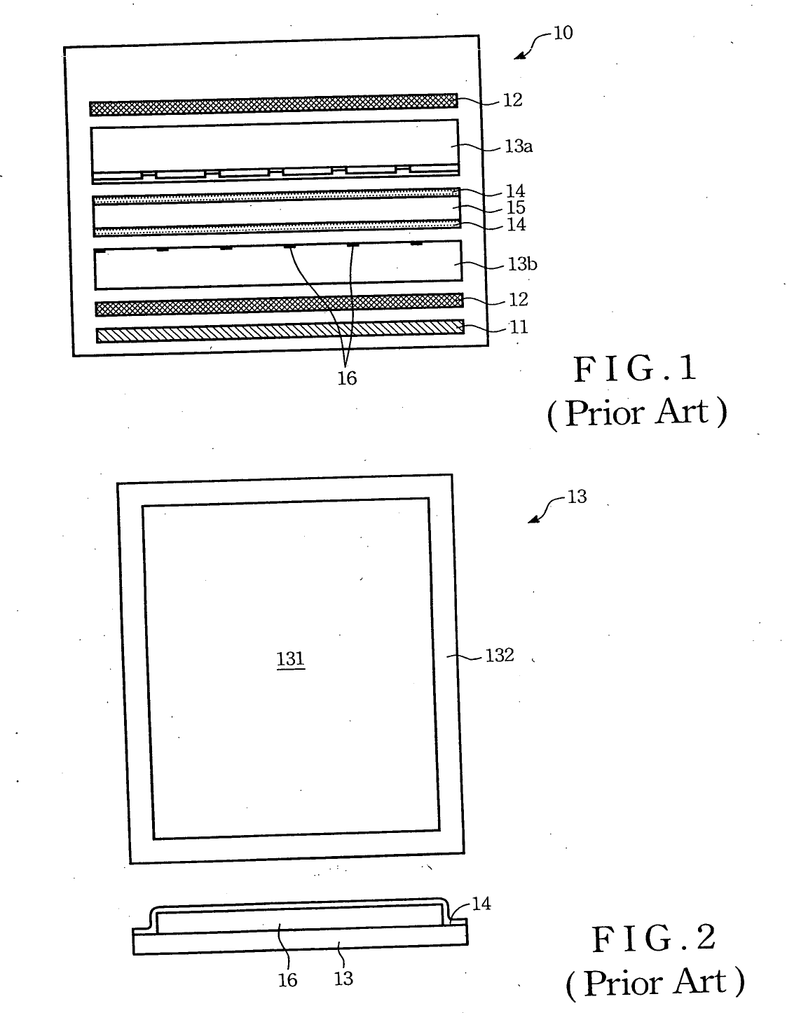

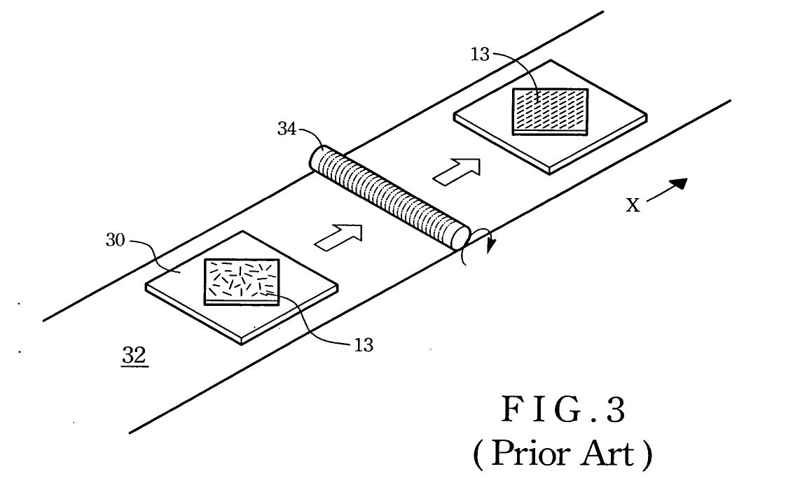

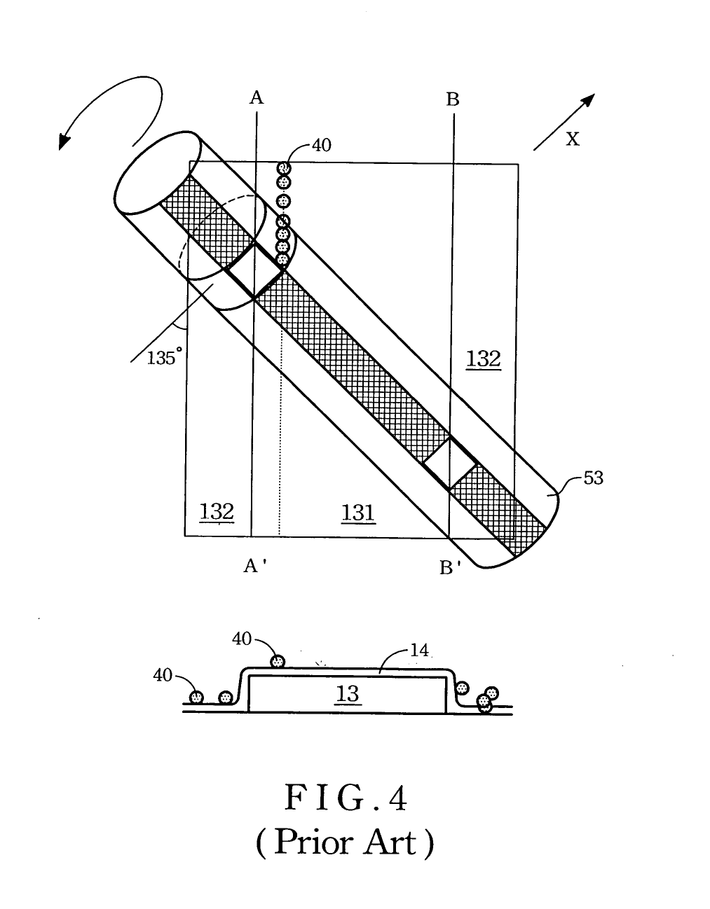

### DESCRIPTION OF THE PREFERRED EMBODIMENT

The invention disclosed herein is directed to a method and an apparatus for rubbing alignment films. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

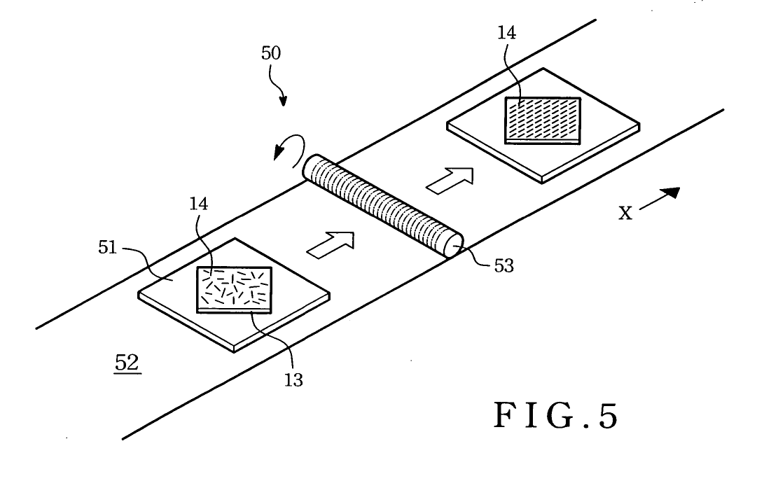

Referring to FIG. 5, a preferred embodiment of the apparatus 50 for rubbing the alignment films in accordance with the present invention is shown. The apparatus 50 can include at least a carrier plate 51 (two shown in the figure), a conveying device 52 and an inverse roller 53 with cloth on a surface thereof. The carrier plate 51 can be used to bear thereupon a glass substrate 13. The conveying device 52 capable of engaging the carrier plate 51 is used to transport or feed the glass substrate 13 along a predetermined direction X. The inversed roller 53 wrapped by cloth for rubbing is arranged to cross the conveying device 52 for rubbing the glass substrate 13 passing therebeneath. In particular, an angle can be formed between the inversed roller 53 and the glass substrate 13. Preferably, the angle is 45°.

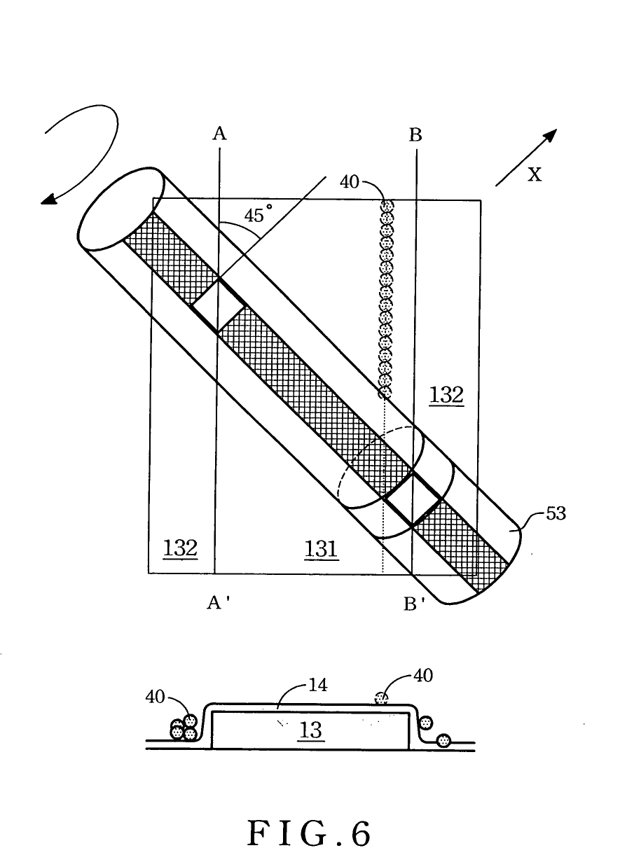

Referring to FIG. 6, while the glass substrate 13 fed by the conveying device 52 is passing the inversed roller 53, the surface of the alignment film 14 on the glass substrate 13 can be rubbed to align at an in-stream direction the same as the predetermined direction X by the inversed roller 53. Similar to the conventional design, the glass substrate 13 can include a visible region 131 and an invisible region 132 surrounding the visible region 131. The visible region 131 can include a plurality of thin film. transistors or transparent electrodes. The invisible region 132 can utilize a shielding layer (not shown in the figure) to achieve a light-shielding effect. It is noted that elevation drops exist at the conjunctions A-A′ and B-B′ of the visible region 131 and the invisible region 132. Also, the alignment film 14 is coated on top of the glass substrate 13.

As mentioned above, chips 40 are always possible while rubbing the alignment film 14 at the conjunctions A-A′ and B-B′ of the visible region 131 and the invisible region 132. In the present invention, the inversed roller 53 is rotated to contribute a tangential rubbing at an in-stream direction the same as the feeding direction or the predetermined direction X of the glass substrate 13 as well as the alignment film 14, so the chips 40 generated during the rubbing operation can either drop freely onto the already-rubbed (or downstream) alignment film 14 or be carried immediately away the alignment film 14 by the cloth of the inversed roller 53 and travel at least a roller turn before dropped back to the alignment film 14 at the another side, i.e. the upstream side with respect to the direction X. Definitely, no hard contact of the chips 40 upon the alignment film 14, under the depression of the roller, to scratch the rubbed alignment film 14 can occur. In practice, thanks for the angling arrangement between the inversed roller 53 and the passing glass substrate 13, the chips 40 at the upstream side of the visible region 131 of the alignment film 14 will move gradually to sides and drop to accumulate in the invisible region 132. Upon such an arrangement, an accumulated line of chips 40 can be formed at the rubbed alignment film 14 in the invisible region 132 by about 1-cm spacing to the conjunction A-A′ or B-B′.

Since the chips 40 generated from rubbing the alignment film 14 by utilizing the apparatus 50 of the present invention are finally rested in the invisible region 132, the display quality of the LCD having the glass substrate 13 can be rarely affected. Also, because the chips 40 are dropped back to the upstream or yet-to-rub side of the alignment film 14, the chips 40, even rotate again with the inversed roller 53, can make no harm or scratch to the downstream portion of the alignment film 14 that has been rubbed already. Upon such an arrangement, the visible region 131 of the glass substrate 13 can then be free of scratches or dents by the chips 40.

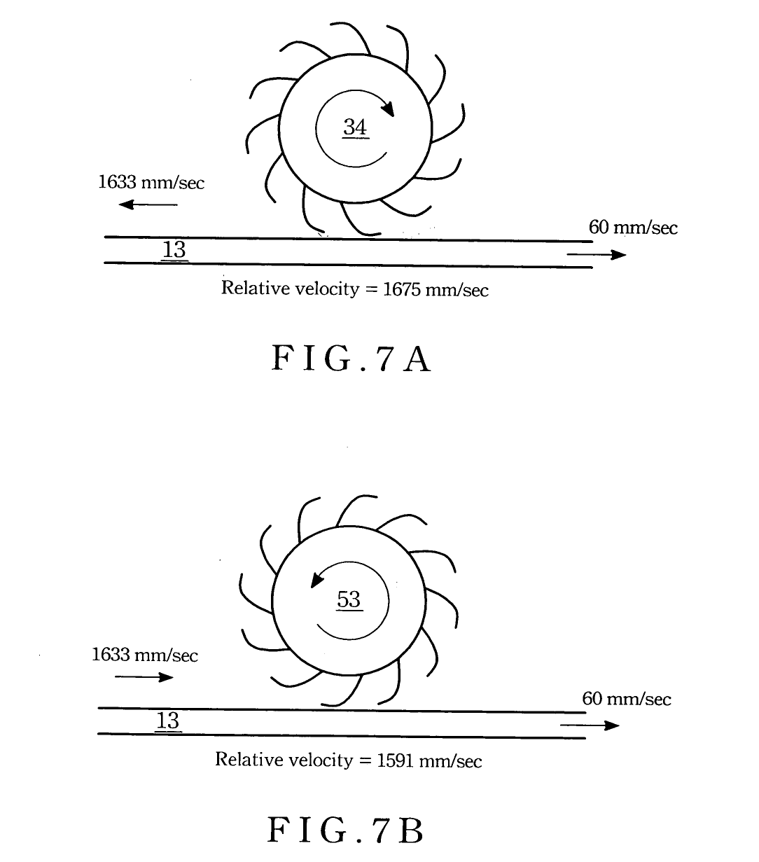

Referring to FIG. 7A and FIG. 7B, difference of the arrangement of the roller and the glass substrate between the prior art and the present invention is illustrated. Generally, the roller, either a conventional roller 34 or the inversed roller 53 of the present invention, is operated at a rate to contribute a tangential velocity of about 1633 mm/sec, and a typical conveying speed of the glass substrate 13 is about 60 mm/sec. Because a 45-degree angling, for example, exists between the roller 34 or 53 and the glass substrate 13, the effective velocity aligning with the feeding direction of the glass substrate 13 will be 42.4 mm/sec. As shown in FIG. 7A, the relative velocity at the bottom of the conventional roller 34 with respect to the glass substrate 13 will be 1675 mm/sec. On the other hand, as shown in FIG. 7B the relative velocity at the bottom of the inversed roller 53 with respect to the glass substrate 13 will be 1591 mm/sec. In practice, such a difference in relative velocity at the bottom of the roller is pretty small and thus can make no effect on the operation of the roller and the conveying device.

By providing the present invention, the method and the apparatus for rubbing alignment films can be operated without changing the operation parameters of the roller and the conveying device. Also, the notorious scratch problem in the visible region by the chips can be successfully resolved. Therefore, the MURA phenomenon in the art can be cured and the display quality of the LCD can be ensured as well.

While the present invention has been particularly shown and described with reference to a preferred embodiment, it will be understood by those skilled in the art that various changes in form and detail may be without departing from the spirit and scope of the present invention.

I claim:

1. A method for rubbing alignment films, comprising the steps of:
providing a glass substrate having a visible region and an invisible region;
coating at least one alignment film onto the glass substrate in a thickness of about 500 angstroms to about 1000 angstroms;
conveying the glass substrate along a predetermined direction; and
applying an inversed roller with cloth on a surface thereof to rub the at least one alignment film at an in-stream direction the same as the predetermined direction so as to make chips rubbed off the alignment film not to contact with the alignment film on the visible region which has been rubbed by the cloth.

2. The method according to claim 1, wherein said alignment film is made of a polyamic acid or a polyamide.

3. The method according to claim 1, wherein said glass substrate and said inversed roller form a predetermined angle.

4. The method according to claim 3, wherein said predetermined angle is about 45 degrees.

5. The method according to claim 1, wherein said visible region is located at a central area of said glass substrate and includes one of a plurality of thin film transistors and a plurality transparent electrodes.

6. The method according to claim 1, wherein said invisible region surrounds said visible region.
